(19) United States
(12) Patent Application Publication
(10) Pub. No.: US 2009/0030563 A1
(43) Pub. Date: Jan. 29, 2009

(54) Systems And Methods For Providing Localized Heat Treatment Of Metal Components

(75) Inventor: William H. Beacham, JR., Enfield, CT (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNITED TECHNOLOGIES CORP., East Hartford, CT (US)

(21) Appl. No.: 11/828,562

(22) Filed: Jul. 26, 2007

(51) Int. Cl. G06F 17/00

(52) U.S. Cl. 701/3

(57) ABSTRACT

Systems and methods for defining information provided by aircraft are provided. An exemplary method, involving an aircraft that is operative to provide information in a first report format, includes: communicating information corresponding to a second report format definition to the aircraft, wherein the information corresponding to the second report format definition is received at the aircraft via wireless communication; and receiving, from the aircraft, information complying with the second report format definition.

### BACKGROUND

1. Technical Field

The disclosure generally relates to communication with aircraft.

2. Description of the Related Art

Modern commercial aircraft typically contain avionics called an Aircraft Condition Monitoring System (ACMS). An ACMS typically performs a variety of functions, such as acquiring data, computing current flight mode, and detecting the occurrence or non-occurrence of events. Additionally, an ACMS typically stores data for later analysis and provides a data loader interface for enabling the extraction and/or uploading of data.

In this regard, extracting data from an ACMS for analysis or uploading data to the ACMS in order to alter data report formats, for example, is accomplished by physical connection of a device to the data loader interface, which is located on the aircraft. Thus, aircraft operator personnel physically visit the aircraft, connect a portable data loader to the ACMS via the data loader interface, and upload data regarding a new report configuration when a new report format for the data is desired.

### SUMMARY

In this regard, systems and methods for defining information provided by aircraft are provided. An exemplary embodiment of such a method, involving an aircraft that is operative to provide information in a first report format, comprises: communicating information corresponding to a second report format definition to the aircraft, wherein the information corresponding to the second report format definition is received at the aircraft via wireless communication; and receiving, from the aircraft, information complying with the second report format definition.

Another exemplary embodiment of a method comprises: providing information from the aircraft in a first report format; receiving at the aircraft information corresponding to a second report format definition, wherein the information corresponding to the second report format definition is received via wireless communication; and providing information from the aircraft in accordance with the second report format definition.

An exemplary embodiment of a system, involving an aircraft operative to provide information in a first report format, comprises a Report Reconfiguration System operative to: provide information corresponding to a second report format definition to the aircraft, wherein the information corresponding to the second report format definition is received at the aircraft via wireless communication; and receive, from the aircraft, information complying with the second report format definition.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale.

FIG. 1 is schematic diagram depicting an embodiment of a system for defining information provided by an aircraft.

FIG. 2 is a flowchart depicting functionality of an embodiment of a system, such as that depicted in FIG. 1.

FIG. 3 is a schematic diagram depicting another embodiment of a system for defining information provided by an aircraft.

FIG. 4 is a flowchart depicting functionality of another embodiment of a system for defining information provided by an aircraft.

FIG. 5 is a flowchart depicting functionality of another embodiment of a system for defining information provided by an aircraft.

### DETAILED DESCRIPTION

As will be described in detail here, systems and methods for defining information provided by aircraft are provided. In some embodiments, wireless communication is used to facilitate reformatting of data acquired by one or more aircraft systems. Reformatting in this context refers to the re-arrangement, selection and/or definition of data items. By way of example, a wireless receiver located on an aircraft can be used to receive data formatting instructions provided by a remote server, with such instructions being used to reformat data provided by an Aircraft Condition Monitoring System (ACMS).

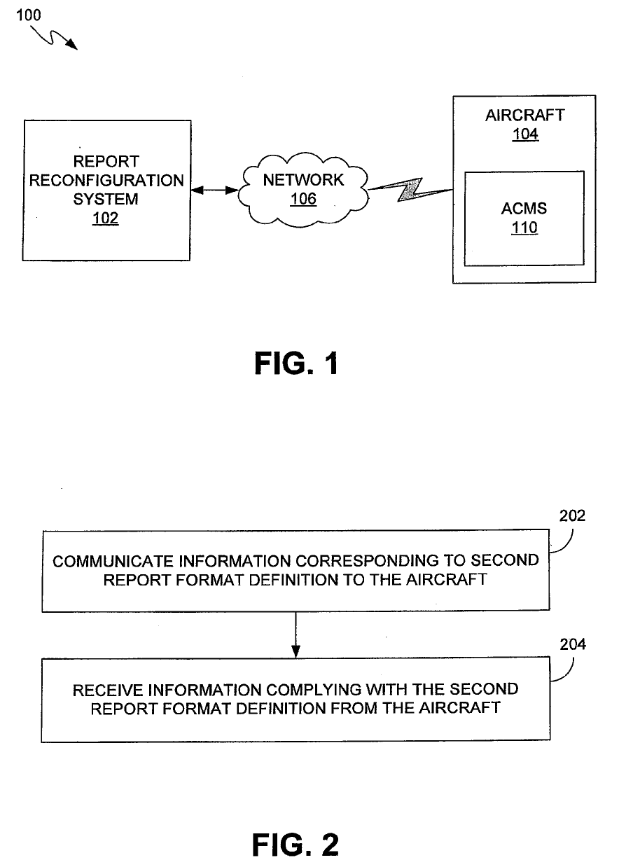

In this regard, FIG. 1 is a schematic diagram depicting an embodiment of a system for defining information provided by an aircraft. As shown in FIG. 1, system 100 incorporates a Report Reconfiguration System 102 that communicates with an aircraft 104 via communication network 106. Although communication network 106 can comprise one or more networks and/or network types, in this embodiment, at least the portion of the communication network that provides the direct interface with the aircraft involves wireless communication, e.g., cellular or 802.11.

Notably, information provided from Report Reconfiguration System 102 to aircraft 104 includes instructions corresponding to the format of data that the aircraft is to acquire and/or report. Responsive to receipt of the information from the Report Reconfiguration System, data complying with the received instructions can be acquired, formatted and/or transmitted for use. In this embodiment, the data that is to be acquired, formatted and/or transmitted corresponds to a customizable portion of the data that is handled by an ACMS 110 of the aircraft although, additionally or alternatively, data from other systems could be involved in other embodiments.

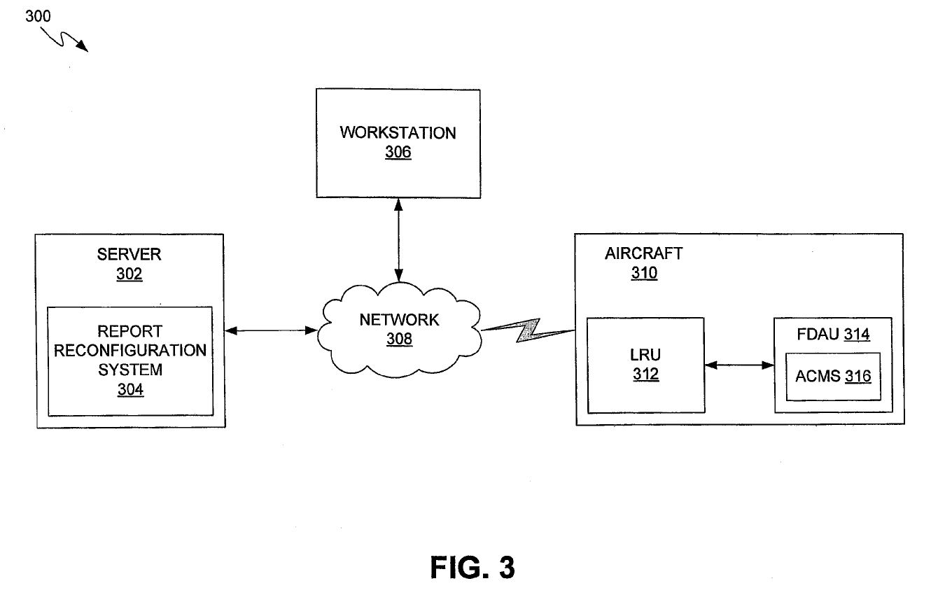

Functionality of an embodiment of a Report Reconfiguration System is depicted in flowchart of FIG. 2. As shown in FIG. 2, the functionality (or method) may be construed as beginning at block 202, in which information corresponding to a second report format definition is communicated to an aircraft. Notably, the aircraft has previously been configured to provide information in a first report format that is different from the second report format. That is, the second report format differs from the first report format with respect to the data that is requested and/or the arrangement of that data.

In block 204, information complying with the second report format definition is received from the aircraft. In this embodiment, the Report Reconfiguration System is involved in both providing information corresponding to a modification of the report format to the aircraft and receiving information from the aircraft. However, various other embodiments could segregate these functions.

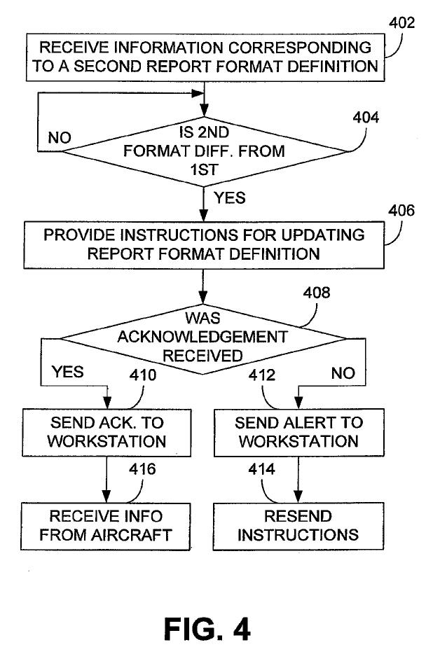

FIG. 3 schematically depicts another embodiment of a system for defining information provided by an aircraft. As shown in FIG. 3, system 300 includes a server 302 that is used to implement an embodiment of a Report Reconfiguration System 304. Server 302 communicates with a workstation 306 via a network 308. In this regard, a user interfacing with the workstation can provide inputs corresponding to instructions that are used to modify the report format provided by one or more aircraft.

FIG. 3 also depicts an aircraft 310 that includes a wireless communication capability facilitated by a line replaceable unit (LRU). In this embodiment, the LRU is a Dual-Architecture Microserver 312 that functions, in pertinent part, as a communication interface for a Flight Data Acquisition Unit (FDAU) 314, which incorporates ACMS functionality 316. Specifically, the Dual-Architecture Microserver LRU is communicatively coupled to the FDAU, such as by a wired connection, and includes a wireless transceiver capable of communicating with a wireless network. More information on exemplary embodiments of Dual-Architecture Microserver LRUs can be found in U.S. Patent Publication 2003/0105565, which is incorporated by reference herein.

In operation, the system of FIG. 3 can operate in one or more of a push mode and a pull mode. Specifically, when operating in a push mode, a change to a requested report format that is directed via the workstation causes instructions corresponding to the requested change to be sent to the aircraft. Responsive to receipt of the instructions by the Dual-Architecture Microserver LRU, information corresponding to the requested change is communicated from the Dual-Architecture Microserver LRU to the FDAU so that the requested change can be made. In some of these embodiments, implementation of the requested change can be acknowledged by the FDAU, with such acknowledgement being indicated back to the Report Reconfiguration System via wireless communication capability of the Dual-Architecture Microserver LRU.

Additionally or alternatively, failure to properly implement the requested change can result in any partially received instructions being disregarded and/or otherwise deleted so that a previous, properly implemented report format will continue to be used by the aircraft. Notably, in some embodiments, failure to properly implement a requested change also can be indicated to the Report Reconfiguration System and/or associated workstation. Note also that the Dual-Architecture Microserver LRU can acknowledge receipt of instructions regardless of whether or not those instructions are communicated to another component, such as the FDAU.

When operating in the pull mode, an aircraft system can be configured to communicate with the Report Reconfiguration System periodically and/or responsive to one or more triggering events. By way of example, in some embodiments, an aircraft mounted component, e.g., a Dual-Architecture Microserver LRU, can be configured to initiate communication with a Report Reconfiguration System in order to check for changes to a report format. For instance, the initiation of such a communication could be responsive to power-up of a component associated with data acquisition, formatting and/or transmission. In the embodiment of FIG. 3, for example, the triggering event is power-up of the Dual-Architecture Microserver LRU.

Regardless of the technique used for causing the Report Reconfiguration System to be contacted, once such communication has been established, a determination is made as to whether the current report format definition associated with the Report Reconfiguration System corresponds to that being used by the aircraft. Notably, either or both of the Report Reconfiguration System and an aircraft mounted component can facilitate such a determination. If it is determined that the aircraft is not utilizing the current report format definition associated with the Report Reconfiguration System, information for modifying the report format of the aircraft can be communicated to the aircraft for implementation. Once again, one or more of various acknowledgments and/or failures can be communicated from the aircraft to the Report Reconfiguration System and/or workstation based on whether or not the receipt of associated instructions and/or implementation of any change has been successful.

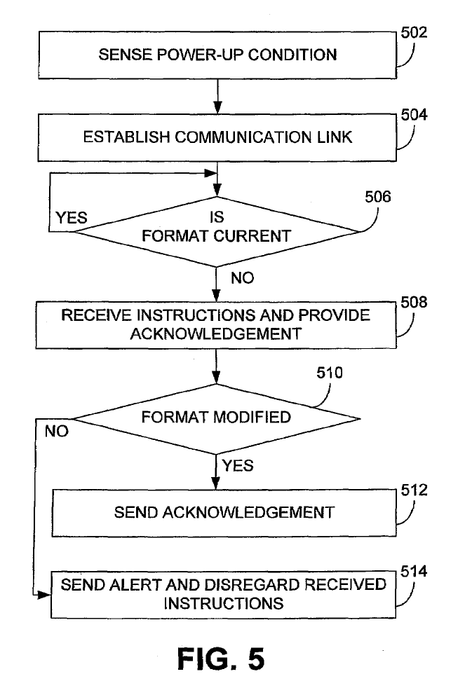

FIG. 4 is a flowchart depicting functionality associated with an embodiment of a system for defining information provided by an aircraft. In particular, FIG. 4 depicts server-side functionality, e.g., functionality of an embodiment of a Report Reconfiguration System. As shown in FIG. 4, the functionality (or method) may be construed as beginning at block 402, in which information corresponding to a second report format definition is received. In some embodiments, such information is provided by a workstation. In block 404, a determination is made to whether the second report format definition differs from a first report format definition. Notably, the first report format definition may be one that was previously provided to the Report Reconfiguration System and/or one that is currently being implemented by one or more aircraft. If it is determined that the second report format definition differs from the first report format definition, instructions for updating the report format from the first format to the second format is transmitted to the appropriate aircraft, such as depicted in block 406.

In block 408, a determination is made as to whether an acknowledgement has been received from the aircraft indicating that the second report format definition has been received and/or properly implemented. If such an acknowledgement is received, the Report Reconfiguration System can forward a similar acknowledgement to the workstation, such as via an email notification for example (block 410). If, however, such an acknowledgement is not received, an alert notification can be sent to the workstation and/or designated individuals. The instructions for updating the reporting format from the first format to the second format also can be transmitted again to the aircraft (blocks 412 and 414) in one or more re-try attempts. The process then returns to block 408. Thereafter, an acknowledgement (block 410) and information complying with the second data format definition are received from the aircraft (416).

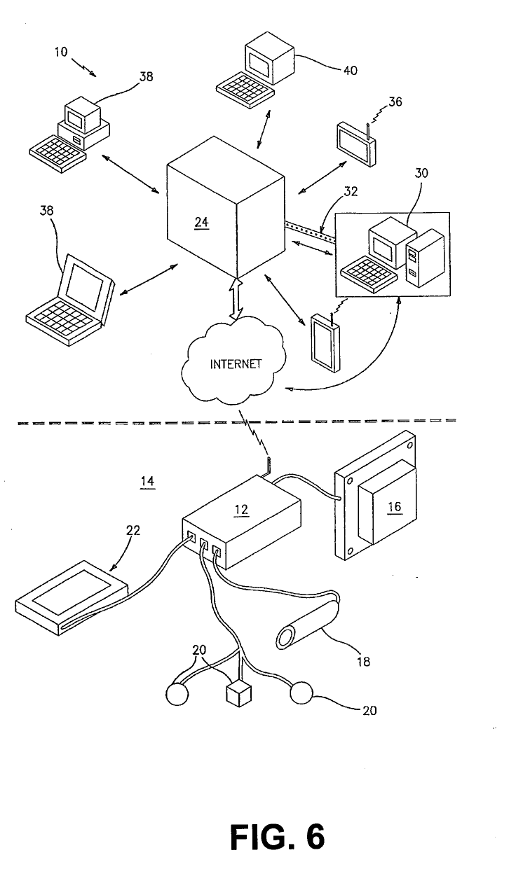

FIG. 5 is a flowchart depicting functionality associated with another embodiment of a system for defining information provided by an aircraft. In particular, FIG. 5 depicts aircraft-side functionality, e.g., functionality performed by an embodiment of a Dual-Architecture Microserver LRU. As shown in FIG. 5, the functionality (or method) may be construed as beginning at block 502, in which a power-up condition is sensed. Responsive to the power-up condition, a communication link is established with a Report Reconfiguration System so that a determination can be made as to whether or not the report format implemented by the aircraft is current (block 504). If it is determined that the report format is not current (block 506), information corresponding to the current report format is received (block 508). Notably, responsive to receiving the instructions for modifying the report format definition, an acknowledgement can be sent.

In block 510, a determination is made as to whether or not the received information has been used to modify the report format properly (block 510). If it is determined that the modification was successful, an acknowledgement is sent to the Report Reconfiguration System (block 512). If, however, it is determined that the modification failed, an alert indication can be communicated to the Report Reconfiguration System (block 514). Additionally, in this embodiment, failure to modify the report format properly also results in the received information being disregarded such that the aircraft resorts to the previously implemented report format (block 514). In other embodiments, failure to modify could result in a switch to a default format or to no format at all.

Various functionality, such as that described above in the flowcharts, may be implemented in hardware and/or software. In this regard, a computing device can be used to implement various functionality, such as that depicted in FIGS. 4 and 5.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set), a macroprocessor, or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

It should be emphasized that the above-described embodiments are possible examples of implementations. Many variations and modifications may be made to the above-described embodiments.

1. A method for defining information provided by an aircraft, the aircraft being operative to provide the information in a first report format, said method comprising:
communicating information corresponding to a second report format definition to the aircraft, wherein the information corresponding to the second report format definition is received at the aircraft via wireless communication;
using a server located on the aircraft to update the first report format with the second report format definition such that information complying with the second report format definition is provided from the aircraft;
outputting, from the aircraft, information complying with the second report format definition; and
receiving, from the aircraft, the information complying with the second report format definition.

2. The method of claim 1, further comprising receiving user inputs at a workstation, the user inputs corresponding to the second report format definition.

3. The method of claim 2, wherein communicating the information corresponding to the second report format definition to the aircraft is performed in response to determining that the second report format definition differs from a first report format definition currently being used by the aircraft.

4. The method of claim 3, wherein:
information corresponding to the second report format definition is stored on a server; and
determining that the second report format definition differs from the first report format definition currently being used by the aircraft is determined by the server.

5. The method of claim 1, further comprising receiving an acknowledgement from the aircraft that the information corresponding to the second report format definition was received.

6. The method of claim 1, wherein the second report format definition involves at least some data that is different than data of the first report format definition.

7. A method for defining information provided by an aircraft, said method comprising:
providing information from the aircraft in a first report format;
receiving at the aircraft information corresponding to a second report format definition, wherein the information corresponding to the second report format definition is received via wireless communication; and
providing information from the aircraft in accordance with the second report format definition.

8. The method of claim 7, wherein:
information corresponding to the second report format definition is stored on a server accessible to the aircraft; and
determining that the second report format definition differs from a first report format definition currently being used by the aircraft is determined at the aircraft.

9. The method of claim 8, wherein receiving, at the aircraft, information corresponding to the second report format definition is instigated in response to the aircraft accessing the server to check for a report format definition change.

10. The method of claim 9, wherein accessing the server to check for a report format definition change is performed responsive to power-up of a component involved in the reporting of the information.

11. The method of claim 10, wherein the component is a Dual-Architecture Microserver line replaceable unit (LRU).

12. A system for defining information provided by an aircraft, the aircraft being operative to provide the information in a first report format, said system comprising:
a Report Reconfiguration System operative to:
provide information corresponding to a second report format definition to the aircraft, wherein the information corresponding to the second report format definition is received at the aircraft via wireless communication; and
receive, from the aircraft, information complying with the second report format definition.

13. The system of claim 12, wherein the Report Reconfiguration System is operative to communicate the information corresponding to the second report format definition to the aircraft responsive to determining that the second report format definition differs from a first report format definition currently being used by the aircraft.

14. The system of claim 12, wherein the Report Reconfiguration System is operative to receive an acknowledgement from the aircraft that the information corresponding to the second report format definition was received.

15. The system of claim 12, further comprising means for accessing the Report Reconfiguration System to check for a report format definition change.

16. The system of claim 15, wherein the means for accessing comprises a Dual-Architecture Microserver line replaceable unit (LRU) operative to perform wireless communication.

17. The system of claim 16, wherein the Dual-Architecture Microserver LRU is operative to access the Report Reconfiguration System responsive to power-up.

18. The system of claim 16, further comprising a Flight Data Acquisition Unit (FDAU) operative to acquire aircraft data and format the flight data in accordance with the report format definition currently being used by the aircraft, and wherein the Dual-Architecture Microserver LRU is operative to communicate a report format definition from the Report Reconfiguration System to the FDAU in order to update the report format definition currently being used by the aircraft.

19. The system of claim 12, wherein the Report Reconfiguration System is further operative to receive user inputs from a workstation corresponding to a second report format definition.

20. The system of claim 19, wherein the Report Reconfiguration System is further operative to send information to the workstation indicating that the second report format definition was not properly implemented at the aircraft.

21. A method for defining information provided by an aircraft, said method comprising:
providing information from the aircraft in a first report format;
communicating information corresponding to a second report format definition to the aircraft;
receiving, at the aircraft, information corresponding to the second report format definition, wherein the information corresponding to the second report format definition is received via wireless communication;
using a server located on the aircraft to update the first report format with the second report format definition such that information complying with the second report format definition is provided from the aircraft;
providing information from the aircraft in accordance with the second report format definition; and
receiving, from the aircraft, information complying with the second report format definition.

22. The method of claim 1, wherein the server is an Internet server.

23. The method of claim 1, wherein the server is configured as a line replaceable unit.

24. The method of claim 1, wherein the server is a hand-held sized microserver.
